(19) United States
(12) Patent Application Publication
(10) Pub. No.: US 2010/0317226 A1
(43) Pub. Date: Dec. 16, 2010

(54) Coaxial Right-Angle Connector

(75) Inventors: Markus Schmid, Surberg (DE); Walter Baldauf, Fridolfing (DE); Alois Otter, Fridolfing (DE); Josef Krautenbacher, Fridolfing (DE); Erich Schwangler, Kuhnhausen (DE); Andreas Bierl, Vachendorf (DE); Tobias-Lars Hoher, Waging am See (DE); Annemarie Konig, Halsbach (DE)

Correspondence Address: LAW OFFICE OF DELIO & PETERSON, LLC., 121 WHITNEY AVENUE, NEW HAVEN, CT, 06510, US

(73) Assignee: ROSENBERGER HOCHFREQUENZTECHNIK GMBH & CO. KG, Fridolfing (DE)

(21) Appl. No.: 12/867,401

(22) PCT Filed: Jan. 8, 2009
(86) PCT No.: PCT/EP09/00068

§ 371 Date: Aug. 12, 2010

(30) Foreign Application Priority Data
Feb. 12, 2008 (DE) 20 2008 001 905.2

(51) Int. Cl. H01R 9/05

(52) U.S. Cl. 439/582

(57) ABSTRACT

A coaxial right-angle connector having a cable-side inner conductor part with two contact sections arranged at a distance from each other, parallel to a longitudinal axis of the cable-side inner conductor part, and in a plane perpendicular to a longitudinal axis of the plug-side inner conductor part. The distance between the contact sections is larger than the pre-determined diameter of the rod of the plug-side inner conductor part. A plate-type contact element is arranged on each contact section. The plate-shaped contact elements are tipped respectively relatively to the contact sections in such a way that the free edges of the plate-shaped contact elements firm a long slit between each other. The distance between the free edges of the plate-shaped contact elements is smaller than the pre-determined diameter of the rod on the free end thereof.

### CROSS REFERENCE TO RELATED APPLICATION

This application is a National Phase filing under 35 U.S.C. §371 of PCT/EP/2009/000068 which was filed Jan. 8, 2009, and claims priority to German Application No. DE 20 2008 001 905.2 filed Feb. 12, 2008.

### BACKGROUND OF THE INVENTION

1. Field of the Invention

The present invention relates to a right-angle plug/socket co-axial connector having an outer connector member, a center conductor member, an insertion end for connection by insertion to a complementary plug/socket co-axial connector, and a cable end for connection to a co-axial cable, the center conductor member being formed in two parts to have an insertion-end part which has a contact end and a cable-end part which has a contact end, the cable-end part of the center conductor being so designed that it can be connected to a center conductor of a co-axial cable which is to be connected to the right-angle plug/socket co-axial connector, the contact ends of the insertion-end part of the center conductor and of the cable-end part thereof being adjacent one another in such a way that they make electrical contact between the insertion-end part of the center conductor and the cable-end part of the center conductor, the insertion-end part of the center conductor taking the form, at its contact end, of a pin which, at a free end of the said pin, is of a predetermined diameter.

2. Description of Related Art

Known from EP 1 019 982 B1 is a co-axial connector member which is intended to be fitted to the end of a co-axial cable. This co-axial connector member has the following: a center conductor, an outer conductor, a center contact which has a longitudinal axis and a rear end connected to the center conductor of the co-axial cable and a front end which is designed to allow the co-axial connector member to be connected to a complementary connector member, an outer contact which is connected to the outer conductor of the co-axial cable, and a transition piece which is fitted to the center conductor of the co-axial cable. The rear end of the center contact has a surrounding neck whose axis coincides with the longitudinal axis of the center contact, whereas the transition piece has an elastic fork having two prongs which form, between them, a seat for the neck. The snapping of the neck into the seat formed by the prongs is performed by pressing the neck into the fork in a direction at right angles to the longitudinal axis of the contact. The free end of each prong of the fork is shaped into a point which is defined by two cylindrical recesses, the axes of which cylindrical recesses are perpendicular to the plane dividing the two prongs and which rectangular recesses are situated on the two sides of a center plane of the transition piece which is at right angles to the plane dividing the two prongs of the fork so that, if the transition piece comes into contact with the neck on the center contact in a position where the transition piece is twisted out of its normal position for snapping-in, a torque is exerted on the transition piece to rotate it to a position in which the neck is able to snap into the fork. However, this has the disadvantage that the transition piece has to be pushed onto the center conductor contact in opposition to a certain resistance, which results in an unwanted axial force acting on the center conductor of the co-axial cable and may cause damage to the center conductor of the co-axial cable. Also, when the co-axial connector is being assembled, the neck of the center conductor contact has to be positioned precisely on the longitudinal axis of the transition piece. This positioning has to be monitored at the time of assembly and, at the same time, only small tolerances are permitted on the individual components. This results in correspondingly high production costs.

### SUMMARY OF THE INVENTION

Bearing in mind the problems and deficiencies of the prior art, it is therefore an object of the present invention to improve a right-angle plug/socket co-axial connector of the above kind in respect of assembly and production costs.

This object is achieved in accordance with the invention by a right-angle plug/socket co-axial connector of the above kind which has the features which are characterized in claim 1. Advantageous embodiments of the invention are described in the other claims.

Still other objects and advantages of the invention will in part be obvious and will in part be apparent from the specification.

The above and other objects, which will be apparent to those skilled in the art, are achieved in the present invention which is directed to a right-angle plug/socket co-axial connector including an outer connector member, a center conductor member, an insertion end for connection by insertion to a complementary plug/socket co-axial connector, and a cable end for connection to a co-axial cable, the center conductor member being formed in two parts including an insertion-end part which has a contact end, and a cable-end part which has a contact end, the cable-end part of the center conductor capable of being connected to a center conductor of a co-axial cable which is to be connected to the right-angle plug/socket co-axial connector, the contact ends of the insertion-end part of the center conductor and of the cable-end part thereof being adjacent one another and in electrical communication with the insertion-end part of the center conductor and the cable-end part of the center conductor, the insertion-end part of the center conductor, at its contact end, forming a pin which, at a free end of the pin, is of a predetermined diameter, wherein the cable-end part of the center conductor comprises, at the contact end, two contact cross-pieces which are arranged to be parallel to a longitudinal axis of the cable-end part of the center conductor and spaced away from one another in a plane perpendicular to a longitudinal axis of the insertion-end part of the center conductor, with a spacing between the contact cross-pieces in the plane perpendicular to the longitudinal axis of the insertion-end part of the center conductor being larger, in a direction perpendicular to the longitudinal axis of the cable-end part of the center conductor, than the predetermined diameter of the pin of the insertion-end part of the center conductor, and further including a contact member arranged on each contact cross-piece in plate form connected to the contact cross-piece on one side and which has a free edge on a side remote from the contact cross-piece, the contact members in plate form each being tilted relative to the contact cross-pieces, in such a way that the free edges of the contact members in plate form include, between them, a longitudinal slot parallel to the longitudinal axis of the cable-end part of the center conductor, with a spacing between the free edges of the contact members in plate form being smaller, in a direction perpendicular to the longitudinal axis of the cable-end part of the center conductor, than the predetermined diameter of the pin at the free end of the latter.

The right-angle plug/socket co-axial connector having the cable-end part of the center conductor include, at the contact end, two U-shaped holding members each comprising two sides of the U-shape and each comprising one of the cross-pieces which acts as a base of the U-shaped holding member and connects the sides of the U-shaped holding member, the longitudinal slot being formed between the free edges of the contact members in plate form in a space between the U-shaped holding members.

At least one side, or both sides, of the U-shape of one U-shaped holding member is connected by an additional connecting cross-piece to a side of the other U-shaped holding member which is situated opposite in a direction perpendicular to the longitudinal axis of the cable-end part of the center conductor. The additional connecting cross-piece may be perpendicular to the longitudinal axis of the cable-end part of the center conductor. The sides of the U-shaped holding member and the contact cross-piece of at least one of the U-shaped holding members are preferably arranged in a plane.

The U-shaped holding members may be so arranged that the planes defined by the sides of the U-shape and the contact cross-pieces of the respective U-shaped holding members are aligned parallel to one another.

The right-angle plug/socket co-axial connector includes an outer conductor member comprising two parts, an insertion-end part and a cable-end part. The insertion-end part of the center conductor is arranged in the insertion-end part of the outer conductor and the cable-end part of the center conductor is arranged in the cable-end part of the outer conductor.

Starting from the predetermined diameter at the free end, the diameter of the pin increases or remains constant in the axial direction. Additionally, the contact members in plate-form, or the contact cross-pieces, or the cable-end part of the center conductor, or any combination thereof, may comprise an elastically resilient material.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a longitudinal section through a preferred embodiment of right-angle plug/socket co-axial connector according to the invention.

FIG. 2 is a view in section of the right-angle plug/socket co-axial connector shown in FIG. 1 on line C-C in FIG. 1.

FIG. 3 is a longitudinal section through the right-angle plug/socket co-axial connector shown in FIG. 1 when the latter has a co-axial cable.

FIG. 4 is a view in section of the right-angle plug/socket co-axial connector shown in FIG. 1 taken in a plane perpendicular to a longitudinal axis of the cable-end part of the center conductor.

FIG. 5 is an exploded view of the right-angle plug/socket co-axial connector shown in FIG. 1.

FIG. 6 is a perspective view of two cable-end parts of center conductors on a carrier strip.

FIG. 7 is a view from the rear, looking in the direction of arrow A in FIG. 6, of a co-axial-cable end of one of the cable-end parts of center conductors shown in FIG. 6.

FIG. 8 is a longitudinal section through one of the cable-end parts of center conductors shown in FIG. 6.

FIG. 9 is a cross-section through one of the cable-end parts of center conductors shown in FIG. 6.

### DESCRIPTION OF THE PREFERRED EMBODIMENT(S)

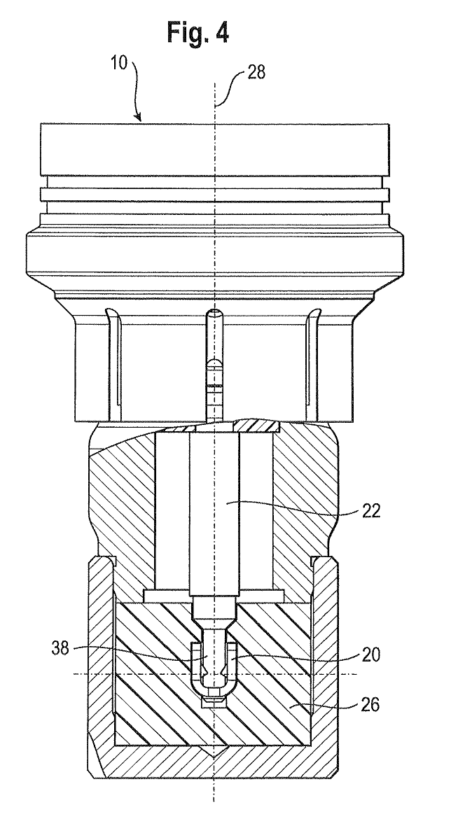

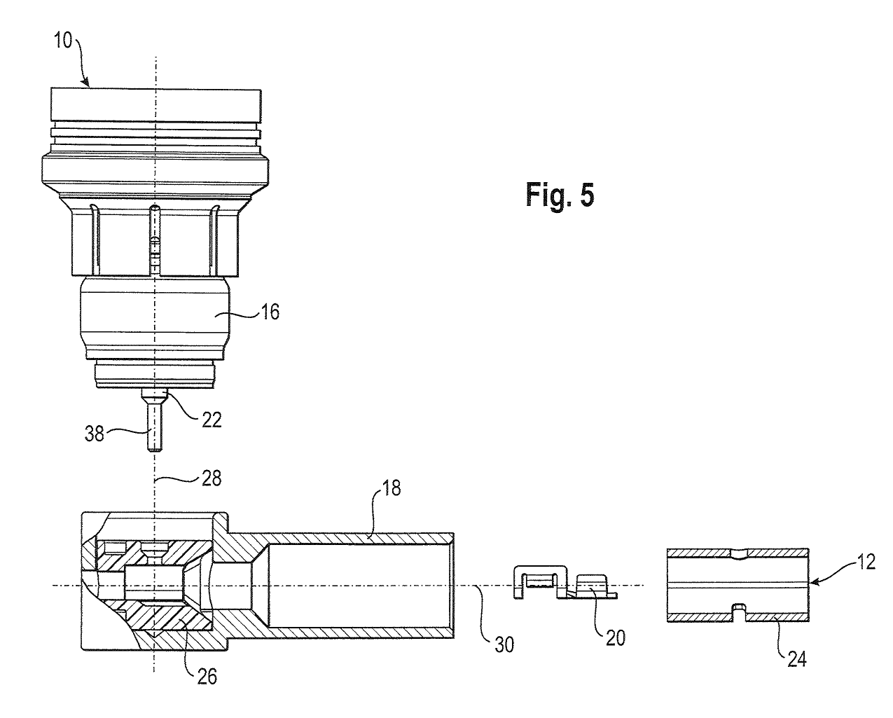

In describing the preferred embodiment of the present invention, reference will be made herein to FIGS. 1-9 of the drawings in which like numerals refer to like features of the invention.

In a right-angle plug/socket co-axial connector of the above kind, provision is made in accordance with the invention for the cable-end part of the center conductor to have, at the contact end, two contact cross-pieces which are arranged to be parallel to a longitudinal axis of the cable-end part of the center conductor and to be spaced away from one another in a plane perpendicular to a longitudinal axis of the insertion-end part of the center conductor, with a spacing between the contact cross-pieces in the plane perpendicular to the longitudinal axis of the insertion-end part of the center conductor being larger, in a direction perpendicular to the longitudinal axis of the cable-end part of the center conductor, than the predetermined diameter of the pin of the insertion-end part of the center conductor, there being arranged on each contact cross-piece a contact member in plate form which is connected to the contact cross-piece on one side and which has a free edge on a side remote from the contact cross-piece, the contact members in plate form each being tilted relative to the contact cross-pieces, i.e., to the plane perpendicular to the longitudinal axis of the insertion-end part of the center conductor, in such a way that the free edges of the contact members in plate form, between them, a longitudinal slot parallel to the longitudinal axis of the cable-end part of the center conductor, with a spacing between the free edges of the contact members in plate form being smaller, in a direction perpendicular to the longitudinal axis of the cable-end part of the center conductor, than the predetermined diameter of the pin at the free end of the latter.

This has the advantage that easy assembly is possible because tolerances are automatically compensated for by the slotted aperture. At the same time, no axial force acts on the co-axial cable when the right-angle plug/socket co-axial connector is being assembled and damage to the co-axial cable at the time of assembly is thus effectively avoided because, as a result of the physical design of the cable-end part of the center conductor, the co-axial cable, together with the cable-end part of the center conductor fitted thereto, can first be slid into the right-angle plug/socket co-axial connector and only then can the insertion-end part of the center conductor be slid into the right-angle plug/socket co-axial connector in such a way that the pin of the insertion-end part of the center conductor presses itself into the longitudinal slot in the cable-end part of the center conductor in opposition to the elastic restorative force from the contact members in plate form at the contact end of the cable-end part of the center conductor. Also, the cable-end part of the center conductor is open in the direction of a longitudinal axis of the insertion-end part of the center conductor, and tolerances on the axial length of the pin of the insertion-end part of the center conductor are thus compensated for automatically. All in all, tolerances in the axial direction on the longitudinal axis of the insertion-end part of the center conductor and in the axial direction on the longitudinal axis of the cable-end part of the center conductor are compensated for.

To enable the longitudinal slot to be set up in a desired position spaced away from a plane defined by the contact cross-pieces, i.e., in line with a longitudinal axis of the cable-end part of the center conductor, the cable-end part of the center conductor has, at the contact end, two U-shaped holding members each comprising two sides of the U and each comprising one of the cross-pieces which acts as a base of the U-shaped holding member and connects the sides of the U-shaped holding member, the longitudinal slot being formed between the free edges of the contact members in plate form in a space between the U-shaped holding members.

To increase the mechanical strength of the arrangement, at least one side, and in particular both sides, of the U of one U-shaped holding member is connected, by an additional connecting cross-piece, to a side of the other U-shaped holding member which is situated opposite in a direction perpendicular to the longitudinal axis of the cable-end part of the center conductor. The additional connecting cross-piece is preferably arranged to be perpendicular to the longitudinal axis of the cable-end part of the center conductor in this case.

In a preferred embodiment, the sides of the U and the contact cross-piece of at least one of the U-shaped holding members are arranged in a plane, with the U-shaped holding members preferably being so arranged that the planes defined by the sides of the U and the contact cross-pieces of the respective U-shaped holding members are aligned parallel to one another.

For assembly which is particularly simple and functions particularly reliably, the outer conductor member is formed in two parts to have an insertion-end part and a cable-end part, the insertion-end part of the center conductor being arranged in the insertion-end part of the outer conductor and the cable-end part of the center conductor being arranged in the cable-end part of the outer conductor.

Starting from the predetermined diameter at the free end, the diameter of the pin may for example increase or remain constant in the axial direction.

Particularly good contact-making force is obtained by making the contact members in plate-form and/or the contact cross-pieces and/or the cable-end part of the center conductor from an elastically resilient material.

Particularly inexpensive manufacture is achieved by allowing the cable-end part of the center conductor to take the form of a stamped or punched, and bent, part.

Particularly good dissipation of thermal energy from the region of the contact between the cable-end part of the center conductor and the insertion-end part of the center conductor is achieved by allowing the insertion-end part of the center conductor to take the form of a turned part. By this means, it is possible for even high electrical powers to be transmitted by the right-angle plug/socket co-axial connector according to the invention without any thermal over-heating and any corresponding damage occurring to the right-angle plug/socket co-axial connector.

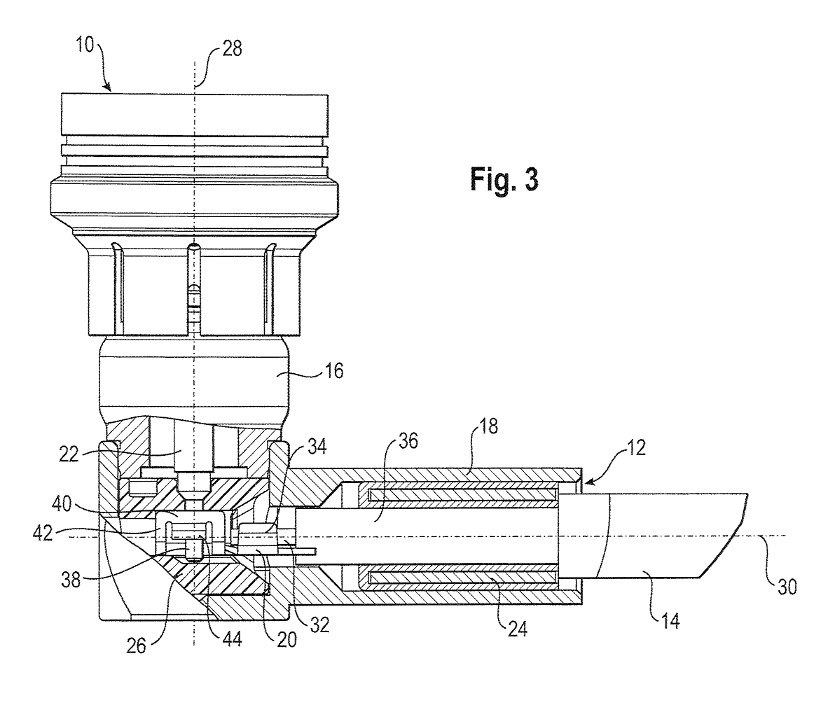

The preferred embodiment of right-angle plug/socket co-axial connector which can be seen in FIGS. 1 to 4 has an insertion end 10 for connection by insertion to a complementary plug/socket co-axial connector (not shown) and a cable end 12 for connection to a co-axial cable 14 (FIG. 3), and it comprises a two-part outer-conductor member which has an insertion-end part 16 and a cable-end part 18, a two-part center-conductor member which has an insertion-end part 22 and a cable-end part 20, a crimp sleeve 24 for fastening by crimping to the co-axial cable 14, and a dielectric 26. The insertion-end part 22 of the center conductor is arranged in the insertion-end part 16 of the outer conductor and the cable-end part 20 of the center conductor is arranged in the cable-end part 18 of the outer conductor. The insertion-end part 22 of the center conductor and the insertion-end part 16 of the outer conductor have, respectively, first longitudinal axes 28, with the insertion-end part 22 of the center conductor and the insertion-end part 16 of the outer conductor being arranged co-axially to one another, i.e., their respective longitudinal axes 28 being in line with one another. The cable-end part 20 of the center conductor and the cable-end part 18 of the outer conductor each have a second longitudinal axis 30, with the cable-end part 20 of the center conductor and the cable-end part 18 of the outer conductor being arranged co-axially to one another, i.e., their respective longitudinal axes 30 being in line with one another.

As can be seen from FIG. 3, the cable-end part 20 of the center conductor is connected electrically and mechanically to a center conductor 32 of the co-axial cable 14 by a crimped connection 34. The crimp sleeve 24 is crimped onto an outer conductor 36 of the co-axial cable 14.

The insertion-end part 22 of the center conductor has, at an end adjacent the cable-end part 20 of the center conductor, a pin 38 which is of a predetermined diameter at a free end, this diameter being constant in the axial direction, i.e. in the direction of the insertion end 10 along the first longitudinal axis 28.

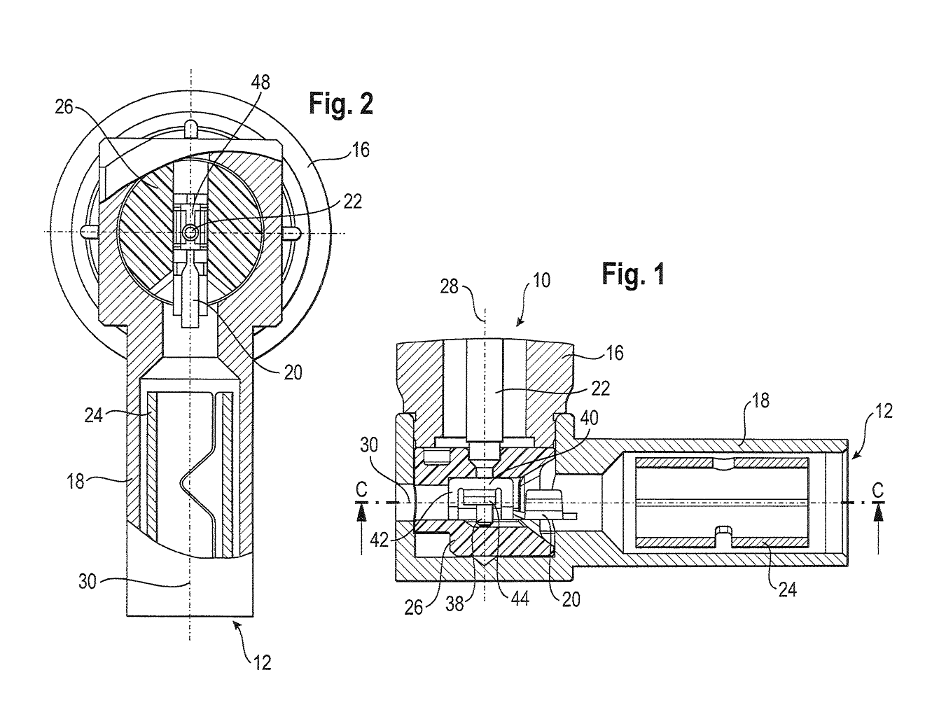

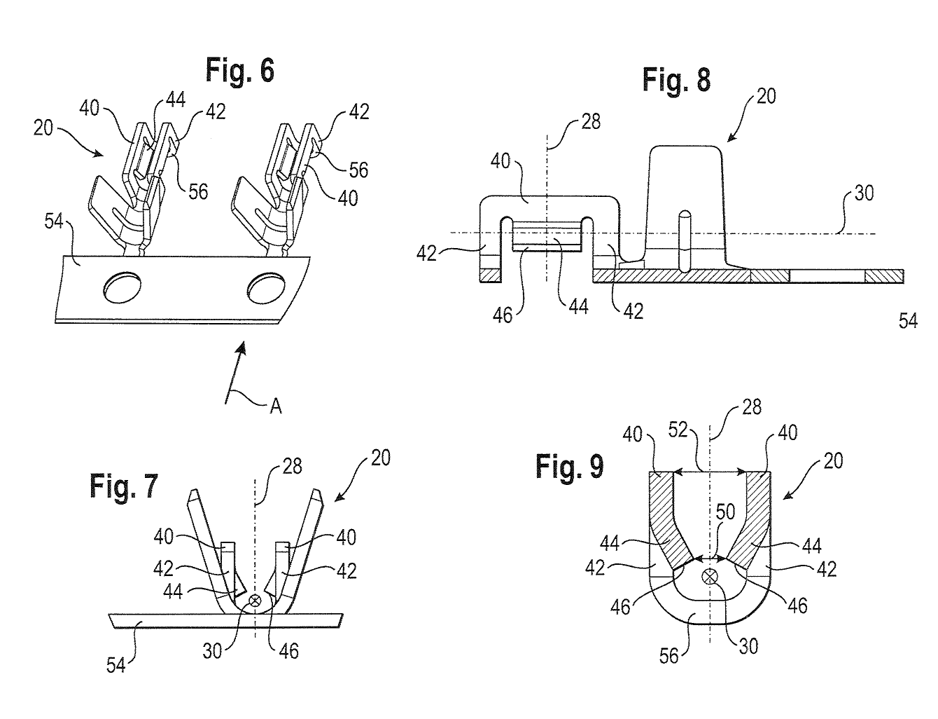

As can be seen from FIGS. 6 to 9, the cable-end part 20 of the center conductor has, at a contact end adjacent the insertion-end part 22 of the center conductor, two contact cross-pieces 40 which are arranged to be parallel to the second longitudinal axis 30 and to lie in a plane perpendicular to the first longitudinal axis 28 and to be spaced away from one another in a direction perpendicular to the second longitudinal axis 30. This spacing 52 (FIG. 9) in a direction perpendicular to the second longitudinal axis 30 is larger than the predetermined diameter of the pin 38. Together with two sides 42 of the U in each case, each of the contact cross-pieces 40 forms a U-shaped holding member, which U-shaped holding members are arranged on two opposing sides of the second longitudinal axis 30 and facing one another. Arranged on each contact cross-piece 40 is a contact plate 44 which is fastened to the given contact cross-piece 40 by one side and which has a free edge at an opposite side remote from the contact cross-piece 40. The contact plates 44 are tilted relative to the contact cross-pieces 40 and the plane perpendicular to the first longitudinal axis 28 in such a way that the free edges 46 of the contact plates 44 form, between them, a longitudinal slot 48 (FIG. 2) which is aligned parallel to the second longitudinal axis 30 and which, in a direction perpendicular to the first and second longitudinal axes 28, 30, is of a minimum width 50 (FIG. 9) which is less than the predetermined diameter of the pin 38.

As can be seen from FIGS. 1, 3, and 4 in particular, the pin 38 engages in the longitudinal slot 48 in such a way that electrical contact is made between the insertion-end part 22 of the center conductor and the cable-end part 20 of the center conductor.

When the right-angle plug/socket co-axial connector according to the invention is being assembled, the cable-end part 20 of the center conductor is first fastened to the exposed center conductor 32 of the co-axial cable 14 and the crimp sleeve 24 is crimped onto the exposed outer conductor 36 of the co-axial cable 14. Having been prepared in this way, the co-axial cable 14 is then slid into the cable end 12 of the cable-end part 18 of the outer conductor of the right-angle plug/socket co-axial connector according to the invention until the cable-end part 20 of the center conductor is in the position shown in FIGS. 1 and 3 or in other words until the first longitudinal axis 28 extends between the two contact cross-pieces 40. The insertion-end part 16 of the outer conductor, together with the insertion-end part 22 of the center conductor arranged therein, is then inserted in the cable-end part 18 of the outer conductor parallel to the first longitudinal axis 28. This engages the pin 38 in the longitudinal slot 48 and makes electrical contact between the insertion-end part 22 of the center conductor and the cable-end part 20 of the center conductor. The arrangement and configuration of the pin 38 and the longitudinal slot 48 automatically compensate for tolerances in the direction of the first longitudinal axis 28 and in the direction of the second longitudinal axis 30, i.e. in two directions in space.

In the preferred embodiment of right-angle plug/socket co-axial connector according to the invention which is shown in FIGS. 1 to 9, the cable-end part 20 of the center conductor takes the form of a stamped or punched, and bent, part and the insertion-end part 22 of the center conductor takes the form of a turned part. By this means, thermal energy is quickly taken away from the electrical contact in the region of the point of contact between the pin 38 and the contact plates 44. This also enables signals of high power to be transmitted via the right-angle plug/socket co-axial connector according to the invention without overheating of the right-angle plug/socket co-axial connector according to the invention, and corresponding damage to the center conductor parts 20, 22 or the dielectric 26, occurring.

As can be seen from FIGS. 6, 7 and 8 in particular, a plurality of cable-end parts 20 of center conductors are made available on a carrier strip 54 for automated assembly of the right-angle plug/socket co-axial connector according to the invention. Together with the automatic compensation for tolerances in two directions in space as explained above, this makes possible efficient, fast and inexpensive assembly of the right-angle plug/socket co-axial connector according to the invention and its making-up into a cable assembly with a co-axial cable 14.

The insertion-end part 16 of the outer conductor can easily be replaced by a different one, thus enabling right-angle plug/socket co-axial connectors making connections of different types, such for example as MCX (micro-coax), SMB, or QMA connectors, to be produced on one and the same machine without any major conversion work.

As can be seen in particular from FIGS. 6 and 9, each two sides 42 of the U of two different U-shaped holding members are connected together by a connecting cross-piece 56. This increases the mechanical strength of the cable-end part 20 of the center conductor.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. Right-angle plug/socket co-axial connector including an outer connector member, a center conductor member, an insertion end for connection by insertion to a complementary plug/socket co-axial connector, and a cable end for connection to a co-axial cable, the center conductor member being formed in two parts including an insertion-end part which has a contact end, and a cable-end part which has a contact end, the cable-end part of the center conductor capable of being connected to a center conductor of a co-axial cable which is to be connected to the right-angle plug/socket co-axial connector, the contact ends of the insertion-end part of the center conductor and of the cable-end part thereof being adjacent one another and in electrical communication with the insertion-end part of the center conductor and the cable-end part of the center conductor, the insertion-end part of the center conductor, at its contact end, forming a pin which, at a free end of the said pin, is of a predetermined diameter, wherein the cable-end part of the center conductor comprises, at the contact end, two contact cross-pieces which are arranged to be parallel to a longitudinal axis of the cable-end part of the center conductor and spaced away from one another in a plane perpendicular to a longitudinal axis of the insertion-end part of the center conductor, with a spacing between the contact cross-pieces in the plane perpendicular to the longitudinal axis of the insertion-end part of the center conductor being larger, in a direction perpendicular to the longitudinal axis of the cable-end part of the center conductor, than the predetermined diameter of the pin of the insertion-end part of the center conductor, and further including a contact member arranged on each contact cross-piece in plate form connected to the contact cross-piece on one side and which has a free edge on a side remote from the contact cross-piece, the contact members in plate form each being tilted relative to the contact cross-pieces, in such a way that the free edges of the contact members in plate form include, between them, a longitudinal slot parallel to the longitudinal axis of the cable-end part of the center conductor, with a spacing between the free edges of the contact members in plate form being smaller, in a direction perpendicular to the longitudinal axis of the cable-end part of the center conductor, than the predetermined diameter of the pin at the free end of the latter.

2. The right-angle plug/socket co-axial connector of claim 1, having the cable-end part of the center conductor include, at the contact end, two U-shaped holding members each comprising two sides of the U-shape and each comprising one of the cross-pieces which acts as a base of the U-shaped holding member and connects the sides of the U-shaped holding member, the longitudinal slot being formed between the free edges of the contact members in plate form in a space between the U-shaped holding members.

3. The right-angle plug/socket co-axial connector of claim 2, including having at least one side, or both sides, of the U-shape of one U-shaped holding member connected by an additional connecting cross-piece to a side of the other U-shaped holding member which is situated opposite in a direction perpendicular to the longitudinal axis of the cable-end part of the center conductor.

4. The right-angle plug/socket co-axial connector of claim 3, including having the additional connecting cross-piece perpendicular to the longitudinal axis of the cable-end part of the center conductor.

5. The right-angle plug/socket co-axial connector of claim 2, including having the sides of the U-shaped holding member and the contact cross-piece of at least one of the U-shaped holding members arranged in a plane.

6. The right-angle plug/socket co-axial connector of claim 5, including having the U-shaped holding members so arranged that the planes defined by the sides of the U-shape and the contact cross-pieces of the respective U-shaped holding members are aligned parallel to one another.

7. The right-angle plug/socket co-axial connector of claim 1, including having an outer conductor member comprise two parts, an insertion-end part and a cable-end part.

8. The right-angle plug/socket co-axial connector of claim 7, including having the insertion-end part of the center conductor arranged in the insertion-end part of the outer conductor and the cable-end part of the center conductor arranged in the cable-end part of the outer conductor.

9. The right-angle plug/socket co-axial connector of claim 1, wherein, starting from the predetermined diameter at the free end, the diameter of the pin increases or remains constant in the axial direction.

10. The right-angle plug/socket co-axial connector of claim 1, wherein the contact members in plate-form, or the contact cross-pieces, or the cable-end part of the center conductor, or any combination thereof, comprise an elastically resilient material.

11. The right-angle plug/socket co-axial connector of claim 1, wherein the cable-end part of the center conductor comprise a stamped or punched, and bent, part.

12. The right-angle plug/socket co-axial connector of claim 1, wherein the insertion-end part of the center conductor comprises a turned part.

13. The right-angle plug/socket co-axial connector of claim 3, including having the sides of the U-shaped holding member and the contact cross-piece of at least one of the U-shaped holding members arranged in a plane.

14. The right-angle plug/socket co-axial connector of claim 4, including having the sides of the U-shaped holding member and the contact cross-piece of at least one of the U-shaped holding members arranged in a plane.

15. The right-angle plug/socket co-axial connector of claim 13, including having the U-shaped holding members so arranged that the planes defined by the sides of the U-shape and the contact cross-pieces of the respective U-shaped holding members are aligned parallel to one another.

16. The right-angle plug/socket co-axial connector of claim 14, including having the U-shaped holding members so arranged that the planes defined by the sides of the U-shape and the contact cross-pieces of the respective U-shaped holding members are aligned parallel to one another.

17. The right-angle plug/socket co-axial connector of claim 4, including having an outer conductor member comprise two parts, an insertion-end part and a cable-end part.

18. The right-angle plug/socket co-axial connector of claim 6, including having an outer conductor member comprise two parts, an insertion-end part and a cable-end part.

19. The right-angle plug/socket co-axial connector of claim 17, including having the insertion-end part of the center conductor arranged in the insertion-end part of the outer conductor and the cable-end part of the center conductor arranged in the cable-end part of the outer conductor.

20. The right-angle plug/socket co-axial connector of claim 18, including having the insertion-end part of the center conductor arranged in the insertion-end part of the outer conductor and the cable-end part of the center conductor arranged in the cable-end part of the outer conductor.

21. The right-angle plug/socket co-axial connector of claim 1 wherein the contact members in plate form are tilted relative to the plane perpendicular to the longitudinal axis of the insertion-end part of the center conductor.

22. The right-angle plug/socket co-axial connector of claim 4, wherein the contact members in plate-form, or the contact cross-pieces, or the cable-end part of the center conductor, or any combination thereof, comprise an elastically resilient material.

23. The right-angle plug/socket co-axial connector of claim 4, wherein the cable-end part of the center conductor comprise a stamped or punched, and bent, part.

24. The right-angle plug/socket co-axial connector of claim 4, wherein the insertion-end part of the center conductor comprises a turned part.
